(19) United States
(12) Patent Application Publication
(10) Pub. No.: US 2023/0276266 A1
(43) Pub. Date: Aug. 31, 2023

(54) METHOD AND APPARATUS TO SUPPORT DATA SUBSCRIPTION SELECTION AND AGGREGATION IN DUAL PS SCENARIO

(71) Applicant: INNOPEAK TECHNOLOGY, INC., Palo Alto, CA (US)

(72) Inventors: Jaehyeuk YANG, Palo Alto, CA (US); Xin XU, Palo Alto, CA (US); Yongsheng SHI, Palo Alto, CA (US)

(73) Assignee: INNOPEAK TECHNOLOGY, INC., Palo Alto, CA (US)

(21) Appl. No.: 18/144,635

(22) Filed: May 8, 2023

Related U.S. Application Data
(63) Continuation of application No. PCT/US2021/059086, filed on Nov. 12, 2021.
(60) Provisional application No. 63/113,443, filed on Nov. 13, 2020.

(51) Int. Cl. H04W 24/02; H04W 8/18

(52) U.S. Cl. CPC H04W 24/02; H04W 8/18

(57) ABSTRACT

An electronic device-implemented method is provided. The method includes: determining a primary data subscription and a secondary data subscription for the electronic device; processing a request for packet service from an application associated with the electronic device; and establishing one or more data connections for the application in response to the request for packet service through at least one of the primary data subscription or the secondary data subscription based on a data subscription policy. Further, an electronic device and a non-transitory storage medium of the electronic device storing instructions using the method are also provided.

### CROSS-REFERENCE TO RELATED APPLICATIONS

The present disclosure is a continuation-application of International (PCT) Patent Application No. PCT/US2021/059086 filed on Nov. 12, 2021, which claims priority to and benefit of U.S. Provisional Application No. 63/113,443 filed on Nov. 13, 2020, the contents of which are hereby incorporated by reference.

### TECHNICAL FIELD

The present disclosure relates to the field of telecommunications technology, and in particular, to a method and an apparatus to support data subscription selection and aggregation in dual PS scenario.

### BACKGROUND

Advances in telecommunication technologies have introduced various developments in various industries. For example, advances in telecommunication technologies have led to improvements in mobile devices, such as mobile phones. Users rely on mobile devices for a variety of services, such as telephony, text messaging, multimedia messaging, email, Internet access, business applications, video games, digital photography, and the like. As telecommunication technologies s continue to advance, the services provided by mobile devices continue to expand. The expansion of services provided by mobile devices allow users to accomplish more with their mobile devices, allowing the users to efficiently conduct business while travelling, conveniently communicate with other users conveniently, quickly access information, and the like. However, as telecommunication technologies continue to advance, so to do the technological challenges arising in the field of telecommunications. Thus, telecommunication technologies continue to face technological challenges.

### SUMMARY

Various embodiments of the present disclosure provide an electronic device-implemented method including determining a primary data subscription and a secondary data subscription for the electronic device; processing a request for packet service from an application associated with the electronic device; and establishing one or more data connections for the application in response to the request for packet service through at least one of the primary data subscription or the secondary data subscription based on a data subscription policy.

Various embodiments of the present disclosure provide an electronic device including at least one processor; and a memory storing instructions that, when executed by the at least one processor, cause the electronic device to perform determining a primary data subscription and a secondary data subscription for the electronic device; processing a request for packet service from an application associated with the electronic device; establishing data connections for the application in response to the request for packet service through the primary data subscription and the secondary data subscription based on a data subscription policy; and aggregating the data connections based on a satisfaction of an aggregation condition, wherein the aggregation condition is based on at least one of: user preferences, a threshold data size, a threshold throughput, external data sharing, or capacities associated with the primary data subscription and the secondary data subscription.

Various embodiments of the present disclosure provide a non-transitory storage medium of an electronic device storing instructions that, when executed by at least one processor of the electronic device, cause the electronic device to perform determining a primary data subscription and a secondary data subscription for the electronic device; processing a request for packet service from an application associated with the electronic device; establishing a data connection for the application in response to the request for packet service through the primary data subscription based on a data subscription policy; determining a service failure or a service degradation associated with the data connection; switching the data connection to be through the secondary data subscription; recovering the primary data subscription; and switching the data connection to be through the primary data subscription.

These illustrative embodiments are mentioned not to limit or define the disclosure, but to provide examples to aid understanding thereof. Additional embodiments are discussed in the Detailed Description, and further description is provided there.

### BRIEF DESCRIPTION OF THE DRAWINGS

The present disclosure, in accordance with one or more various embodiments, is described in detail with reference to the following figures. The figures are provided for purposes of illustration only and merely depict typical or exemplary embodiments.

FIG. 1 illustrates an example network in which various embodiments of the present disclosure may be implemented.

FIG. 2 illustrates an example device that can support data subscription selection and aggregation according to various embodiments of the present disclosure.

FIG. 3 illustrates a computing component that includes one or more hardware processors and machine-readable storage media storing a set of machine-readable/machine-executable instructions according to various embodiments of the present disclosure.

FIG. 4 illustrates an example scenario associated with recovery of a service failure or a service degradation according to various embodiments of the present disclosure.

FIG. 5 illustrates a block diagram of an example computing system in which various embodiments of the present disclosure may be implemented.

The figures are not exhaustive and do not limit the present disclosure to the precise form disclosed.

### DETAILED DESCRIPTION

A subscriber identification module (SIM) allows mobile devices to access various telecommunication services, such as Global System for Mobile Communications (GSM) services, Long-Term Evolution (LTE) services, or 5G services. A dual SIM device, such as a dual SIM smartphone, can refer to a device that can include or use two separate SIM cards. Depending on the type of dual SIM device, each of the two SIM cards can be active at the same time. For example, a dual SIM dual active (DSDA) device can allow a user to make and receive calls using both SIM cards at the same time. In a dual SIM dual standby (DSDS) device, only one of the two SIM cards can be used at a given time for making and receiving calls. A user can select which of the two SIM cards is to be used. A DSDS device can also allow both active SIM cards to receive communications at any time, so long as both of the SIM cards are in standby mode.

In conventional DSDS devices, only one SIM is used for regular packet service at a time. The use of only one SIM is generally due to limitations related to radio resources or high level operating systems (HLOS) associated with the DSDS device. For example, a modem within a DSDS device may not support operation using dual radios because a single radio resource is shared by both SIMs. As another example, the HLOS of a DSDS device may not support separate data paths to a modem. Because of these limitations, conventional DSDS devices require users to select a SIM to use as a default data subscription (DDS) for packet service. The other SIM cannot be used for packet service at the same time. Thus, a user must switch between SIMs in a DSDS device and cannot make use of both SIMs in the DSDS device at the same time.

Conventional DSDA devices face similar technological challenges as the aforementioned faced by DSDS devices. In conventional DSDA devices, a modem within a DSDA device may support dual radios, but the HLOS associated with the DSDA device typically only supports one SIM for packet service. Thus, a user must select a SIM in a conventional DSDA device to use as a DDS for packet service and switch between SIMs to use both SIMs in the DSDA device separately. Besides the inefficiencies associated with using only one SIM when multiple SIMs are available, switching SIMs can cause packet loss or cause delays for any ongoing data stream during a DDS switch. Thus, in both conventional DSDA devices and conventional DSDS devices, the use of only one SIM for packet service is some of the technological challenges arising in the field of telecommunications technologies.

Accordingly, the present disclosure provides solutions that address the technological challenges described above. In various embodiments, the present disclosure provides for selection and aggregation of data subscriptions associated with multiple SIMs on a device. Selection of a data subscription can improve performance on a device by selecting an appropriate data subscription to serve as a primary data subscription. Aggregation of multiple data subscriptions can improve traffic throughput on the device by allowing the device to use multiple data subscriptions for packet service.

Various embodiments of the present disclosure provide an electronic device-implemented method including determining a primary data subscription and a secondary data subscription for the electronic device; processing a request for packet service from an application associated with the electronic device; and establishing one or more data connections for the application in response to the request for packet service through at least one of the primary data subscription or the secondary data subscription based on a data subscription policy.

In some embodiments of the method, data connections are established through the primary data subscription and the secondary data subscription, and the method further includes aggregating the data connections based on a satisfaction of an aggregation condition, wherein the aggregation condition is based on at least one of: user preferences, a threshold data size, a threshold throughput, external data sharing, or capacities associated with the primary data subscription and the secondary data subscription.

In some embodiments of the method, the method further includes stopping aggregation of the data connections based on a satisfaction of a stop aggregation condition, wherein the stop aggregation condition is based on at least one of: a threshold battery level, a threshold data capacity, or a threshold file size.

In some embodiments of the method, the one or more data connections are associated with a service failure or a service degradation and the method further includes switching the one or more data connections to be through a different data subscription; recovering a data subscription associated with the service failure or the service degradation; and switching the one or more data connections to be through the recovered data subscription.

In some embodiments of the method, the method further includes determining policy rule factors for the data subscription policy associated with the electronic device, wherein the policy rule factors are based on at least one of user preferences, capacity rule factors, application rule factors, traffic rule factors, load balance rule factors, use rule factors, status rule factors, or power rule factors.

In some embodiments of the method, the determining the primary data subscription and the secondary data subscription is based on a user selection or a system selection.

In some embodiments of the method, the processing the request for packet service includes at least one of: determining information associated with the electronic device, determining information associated with the application, determining information associated with a network for packet service, or determining user preferences.

Various embodiments of the present disclosure provide an electronic device including at least one processor; and a memory storing instructions that, when executed by the at least one processor, cause the electronic device to perform determining a primary data subscription and a secondary data subscription for the electronic device; processing a request for packet service from an application associated with the electronic device; establishing data connections for the application in response to the request for packet service through the primary data subscription and the secondary data subscription based on a data subscription policy; and aggregating the data connections based on a satisfaction of an aggregation condition, wherein the aggregation condition is based on at least one of: user preferences, a threshold data size, a threshold throughput, external data sharing, or capacities associated with the primary data subscription and the secondary data subscription

In some embodiments of the electronic device, the electronic device further performs stopping aggregation of the data connections based on a satisfaction of a stop aggregation condition, wherein the stop aggregation condition is based on at least one of: a threshold battery level, a threshold data capacity, or a threshold file size.

In some embodiments of the electronic device, one of the data connections is associated with a service failure or a service degradation, and the electronic device further performs switching the one data connection to be through a different data subscription; recovering a data subscription associated with the service failure or the service degradation; and switching the one data connection to be through the recovered data subscription.

In some embodiments of the electronic device, the electronic device further performs determining policy rule factors for the data subscription policy associated with the electronic device, wherein the policy rule factors are based on at least one of user preferences, capacity rule factors, application rule factors, traffic rule factors, load balance rule factors, use rule factors, status rule factors, or power rule factors.

In some embodiments of the electronic device, the determining the primary data subscription and the secondary data subscription is based on a user selection or a system selection.

In some embodiments of the electronic device, the processing the request for packet service includes at least one of: determining information associated with the electronic device, determining information associated with the application, determining information associated with a network for packet service, or determining user preferences.

Various embodiments of the present disclosure provide a non-transitory storage medium of an electronic device storing instructions that, when executed by at least one processor of the electronic device, cause the electronic device to perform determining a primary data subscription and a secondary data subscription for the electronic device; processing a request for packet service from an application associated with the electronic device; establishing a data connection for the application in response to the request for packet service through the primary data subscription based on a data subscription policy; determining a service failure or a service degradation associated with the data connection; switching the data connection to be through the secondary data subscription; recovering the primary data subscription; and switching the data connection to be through the primary data subscription.

In some embodiments of the non-transitory storage medium, the instructions cause the electronic device to further perform establishing another data connection through the secondary data subscription; and aggregating the data connection and the other data connection based on a satisfaction of an aggregation condition, wherein the aggregation condition is based on at least one of: user preferences, a threshold data size, a threshold throughput, external data sharing, or capacities associated with the primary data subscription and the secondary data subscription.

In some embodiments of the non-transitory storage medium, the instructions cause the electronic device to further perform stopping aggregation of the data connection and the other data connection based on a satisfaction of a stop aggregation condition, wherein the stop aggregation condition is based on at least one of: a threshold battery level, a threshold data capacity, or a threshold file size.

In some embodiments of the non-transitory storage medium, the instructions cause the electronic device to further perform determining policy rule factors for the data subscription policy associated with the electronic device, wherein the policy rule factors are based on at least one of user preferences, capacity rule factors, application rule factors, traffic rule factors, load balance rule factors, use rule factors, status rule factors, or power rule factors.

In some embodiments of the non-transitory storage medium, the determining the primary data subscription and the secondary data subscription is based on a user selection or a system selection.

In some embodiments of the non-transitory storage medium, the processing the request for packet service includes at least one of: determining information associated with the electronic device, determining information associated with the application, determining information associated with a network for packet service, or determining user preferences.

In some embodiments of the non-transitory storage medium, the service failure includes a data stall, a disconnection, or a server timeout, and the service degradation includes a reduction in throughput, or an increase in latency.

In various embodiments, a device, such as a dual SIM device, can determine policy rule factors for a data subscription policy. A data subscription can be selected for establishing a data connection based on the data subscription policy. The data subscription policy can be based on, for example, various user preferences (e.g., provider preferences, data plan preferences), capacity rule factors (e.g., data subscription capacities), application rule factors (e.g., application throughput requirements), traffic rule factors (e.g., quality of service, traffic priority), load balance rule factors (e.g., radio access technology information, throughput thresholds, application priority, traffic type), use rule factors (e.g., work related use, personal use, etc.), status rule factors (e.g., roaming status), power rule factors (e.g., power saving), and the like. A primary data subscription and a secondary data subscription can be determined for the device. When the device receives a packet service request from an application on the device, the device can establish one or more data connections for the application through the primary data subscription and the secondary data subscription based on the data subscription policy. In some cases, the data connection can use either the primary data subscription or the secondary data subscription based on the data subscription policy. For example, the data connection can use either the primary data subscription or the secondary data subscription based on whether the application is a foreground application or a background application, bandwidth requirements associated with the application, and the like. User preferences may also be considered in whether to use the primary data subscription or the secondary subscription. In some cases, the application can use both the primary data subscription and the secondary subscription. Data received through the primary data subscription and the secondary subscription are aggregated together and may provide higher throughput for the application. The aggregation of data subscriptions can be based on satisfaction of certain conditions for aggregating data subscriptions. User preferences may also be considered in whether to aggregate the data subscriptions. By selecting an appropriate data subscription and, in some cases, aggregating data subscriptions, data can be efficiently delivered with improved throughput.

Further, the use of multiple data subscriptions described herein can provide for recovery in cases of service failure or service degradation. In some cases, a data subscription (e.g., a primary data subscription) may stall, degrade, or fail due to, for example, a poor connection, interference, or service outage. In these cases, an alternative data subscription (e.g., a secondary data subscription) can be used to avoid interruptions in a data connection while the service failure or service degradation is resolved. Thus, the present disclosure provides solutions that address technological challenges arising from the use of only one SIM for packet service. The various embodiments described herein provide effective selection of appropriate data subscriptions and aggregation of data subscriptions for efficient and improved data throughput. Further, the various embodiments described herein provide for recovery in cases of service failure or service degradation. The features of the solutions are discussed in further detail herein.

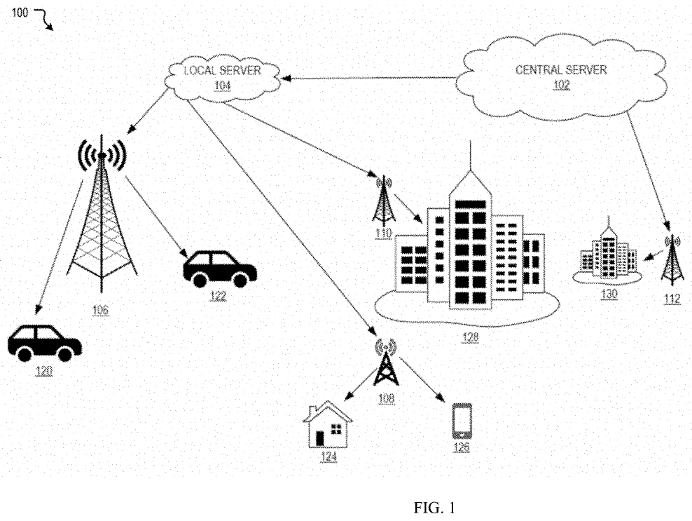

Before describing the details of the various embodiments contemplated herein, it would be beneficial to describe a communications network, such as a cellular or other wireless wide area network (WWAN) to which a device, such as a dual SIM device, may connect. FIG. 1 illustrates an example network 100 in which or with which various embodiments of the present disclosure may be implemented. A mobile network can be thought of as including two component networks, the radio access network (RAN) and the core network

A mobile network's RAN may include various infrastructure, such as base stations/cell towers, masts, in-home/in-building infrastructure, and the like. The RAN allows users of devices, which can be referred to as user equipment (UE), such as smartphones, tablet computers, laptops, vehicle-implemented communication devices (e.g., vehicles having vehicle-to-vehicle (V2V) capabilities), and the like, to connect to the core network. FIG. 1 illustrates a plurality of small base stations or small cells and macro base stations or macro cells (e.g., macro cells 106, 110, and 112, and small cell 108).

Macro cells can refer to tall, high-powered “macro” base stations/cell towers that are able to maintain network signal strength across long, large distances. Macro cells may use multiple input, multiple output (MIMO) antennas that may have various components that allow data to be sent and/or received simultaneously. In the example network 100 of FIG. 1, macro cell 106 may provide wireless broadband coverage and communications to vehicles 120 and 122. Macro cell 110 may provide broadband service to an area, such as a city or municipality 128. Likewise, macro cell 112 may provide broadband coverage to an area, such as a city or municipality 130.

Small cells can refer to wireless transmitters or wireless receivers implemented as micro base stations designed to provide coverage to areas smaller than those afforded coverage by macro cells (e.g., about 100 meters (m) to 200 m for outdoor 5G small cells). Indoor 5G small cell deployments may provide coverage on the order about 10 m. Small cells can be mounted or integrated onto streetlights, utility poles, buildings, and like macro cells, may also leverage massive MIMO antennas. In the example network 100 of FIG. 1, small cell 108 provides broadband coverage to a house 124 and smartphone 126.

The core network may include the mobile exchange and data network used to manage the connections made to, from, or via the RAN. As illustrated in FIG. 1, the core network of network 100 may include central server 102 and local server 104. Central server 102 is shown to effectuate broadband service to area 130 by way of macro cell 112. Central server 102 may also operatively connect to local server 104, which in turn, provides broadband connectivity by way of macro cells 106 and 110, as well as small cell 108. The use of distributed servers, such as local server 104, can improve response times, thereby reducing latency. The core network may leverage network function virtualization (e.g., instantiation of network functions using virtual machines via the cloud rather than hardware) to provide these lower response times, and provide faster connectivity.

Each device or UE (e.g., smartphone, satellite phone, etc.) in a communications network may be uniquely identified by some identifying information that can be stored on a SIM card installed therein. SIM cards are typically provided by network operators or service providers. As described herein, a device or UE that includes multiple SIMs but only supports use of one SIM at a time for packet service fails to efficiently take advantage of the multiple SIMs in the device. Thus, as further described herein, the present disclosure provides for selection and aggregation of data subscriptions, which allows for efficient use of multiple SIMs for improved throughput and, in some cases, data recovery.

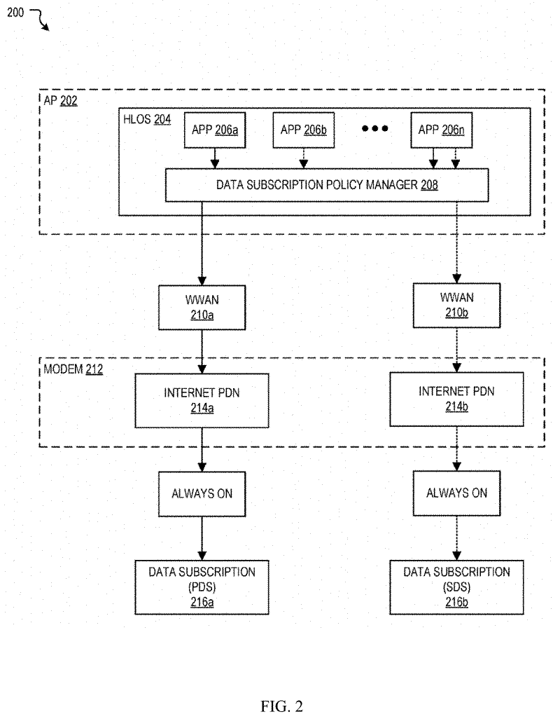

FIG. 2 illustrates an example device 200 that can support data subscription selection and aggregation according to various embodiments of the present disclosure. As illustrated in FIG. 2, the example device 200 can include an application processor (AP) 202 and a modem 212. The AP 202 can support a high level operating system (HLOS) 204. The HLOS 204 can support various applications, APP 206a, 206b, 206n. The various applications, APP 206a, 206b, 206n, can have one or more data connections facilitated by the data subscription policy manager (DSPM) 208. The example device 200 can utilize multiple data connections, illustrated in this example as two data connections, WWAN 210a and WWAN 210b, that are established between the AP 202 and the modem 212. The data connection WWAN 210a can be effectuated between the AP 202 and the modem 212 to support access to Internet public data network (PDN) 214a. The data connection WWAN 210b can be effectuated between the AP 202 and the modem 212 to support access to Internet PDN 214b. These data connections can be effectuated, for example, using a packet data protocol (PDP) to support packet service through SIMs included in the example device 200. The SIMs included in the example device 200 can be associated with primary data subscription (PDS) 216a and a secondary data subscription (SDS) 216b. It should be understood that the “primary” and “secondary” distinctions are not necessarily indicative of a preference for use, although in some embodiments, some preferences may impact selection of a data subscription for use by an application.

As illustrated in FIG. 2, the PDS 216a and the SDS 216b can be always on to support multiple data connections at the same time. The example device 200 can be configured to have two data connections between AP 202 and the modem 212 at all times. Each connection can map to the Internet or a packet service connection with each SIM card over the air, and transmit data and receive data via a network, such as a cellular network. In this way, both SIM cards of the example device 200 can be used, rather than leaving one SIM card unused.

In various embodiments, the DSPM 208 manages requests for packet service from applications, such APP 206a, APP 206b, and APP 206n. The DSPM 208 relies on certain policies, as further described herein, in order to decide which data subscription to assign to an application. These policies can be based on, for example, application requirements, user preferences, system loading, real time data throughput, latency, data plan, roaming status, and the like. The DSPM 208 may also rely on certain policies to determine whether to use multiple data subscriptions, such as PDS 216a and SDS 216b, to achieve a higher throughput. In some cases, the DSPM 208 can determine an issue associated with a data connection, such as a data stall or a poor quality of service. As there are multiple data connections, the DSPM 208 can facilitate data recovery using another data connection that is not experiencing an issue.

As illustrated in FIG. 2, the example device 200 can use multiple SIMs (e.g. SIMs associated with PDS 216a and SDS 216b) separately or simultaneously for various applications. In this example, APP 206a uses a data connection associated with PDS 216a. Based on the data connection associated with PDS 216a, APP 206a can access packet service through Internet PDN 214a. APP 206b uses a data connection associated with SDS 216b. Based on the data connection associated with SDS 216b, APP 206b can access packet service through Internet PDN 214b. APP 206n uses two data connections associated with PDS 216a and SDS 216b. Based on the two data connections associated with PDS 216a and SDS 216b, APP 206n can access packet service through Internet PDN 214a and Internet PDN 214b. These data connections used by APP 206a, 206b, and 206n are facilitated by the DSPM 208. As illustrated in this example, the DSPM 208 can support multiple data connections using multiple SIMs. It should be noted that in the event more than two SIM cards are used, embodiments of the present disclosure can be adapted to handle such scenarios.

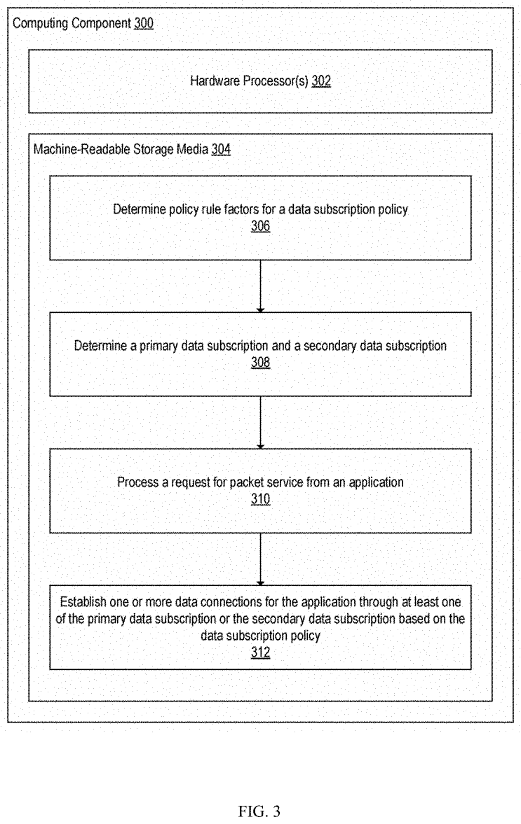

FIG. 3 illustrates a computing component 300 that includes one or more hardware processors 302 and machine-readable storage media 304 storing a set of machine-readable/machine-executable instructions that, when executed, cause the one or more hardware processors 302 to perform an illustrative method for data subscription selection and aggregation, according to various embodiments of the present disclosure. The computing component 300 may be, for example, the computing system (i.e., electronic device) 500 of FIG. 5. The hardware processors 302 may include, for example, the processor(s) 504 of FIG. 5, the application processor 202 of FIG. 2, or any other processing unit described herein. The machine-readable storage media 304 may include the main memory 506, the read-only memory (ROM) 508, the storage 510 of FIG. 5, and/or any other suitable machine-readable storage media described herein.

At block 306, the hardware processor(s) 302 may execute the machine-readable/machine-executable instructions stored in the machine-readable storage media 304 to determine policy rule factors for a data subscription policy. In various embodiments, selection of a primary data subscription and a secondary data subscription for establishing a data connection can be based on a data subscription policy. The data subscription policy can be based on various rule factors, such as user preferences, capacity rule factors, application rule factors, traffic rule factors, load balance rule factors, use rule factors, status rule factors, power rule factors, and the like. In some embodiments, user preferences can include provider preferences, data plan preferences, and the like. A data subscription policy can consider preferences set by a user for data service providers associated with data subscriptions or preferences for data plans associated with the data subscriptions. For example, a user can set a preference for data subscriptions associated with a data service provider over data subscriptions associated with other data service providers. In some embodiments, capacity rule factors can include data subscription capacities and the like. A data subscription policy can consider data capacities associated with data subscriptions and how much of the data capacities have been used. For example, a data subscription with more remaining data capacity (e.g., data capacity reduced by how much data has been used) can be preferred over a data subscription with less remaining data capacity. In some embodiments, application rule factors can include application throughput requirements, bandwidth requirements, capacity requirements, latency requirements, and the like. An application may require a threshold amount of throughput, bandwidth, or latency. A data subscription policy can consider the threshold requirements of the application. For example, a data subscription that satisfies threshold requirements of an application can be preferred over other data subscriptions that do not satisfy the threshold requirements. In some embodiments, traffic rule factors can include quality of service, traffic priority, delay sensitivity, and the like. A data subscription policy can consider various characteristics associated with traffic delivered through a data subscription. For example, a data subscription that provides lower delay (e.g., lower startup latency) and lower bandwidth may be preferred for some applications over other data subscriptions that provide higher delay (e.g., higher startup latency) and higher bandwidth, while the other data subscriptions that provide higher delay and higher bandwidth may be preferred for other applications. In some embodiments, load balance rule factors can include radio access technology (RAT) information, throughput thresholds, application priority, traffic type, and the like. A data subscription policy can consider various factors for balancing traffic load across data subscriptions. For example, a data subscription may be associated with 5G capabilities, and the 5G network to which the data subscription supports access may be experiencing congestion. Another data subscription may be associated with 4G capabilities, and the 4G network to which the data subscription supports access may not be experiencing congestion. It may be preferred for an application that requires a threshold bandwidth throughput greater than the 5G network can offer to use the data subscription associated with 4G capabilities. As another example, data subscriptions associated with higher bandwidth capabilities may be preferred for applications with higher priority over applications with lower priority, and data subscriptions associated with lower bandwidth capabilities may be preferred for applications with lower priority over applications with higher priority. As another example, data subscriptions that support higher upload bandwidth may be preferred for broadcasting or streaming traffic over other data subscriptions that support lower upload bandwidth. In some embodiments, use rule factors can include work related use, personal use, public use, private use, and the like. A data subscription policy can consider usage of packet data for data subscriptions. For example, a data subscription provided by an employer may be preferred for work related traffic over a data subscription provided by a user for personal use. In some embodiments, status rule factors can include roaming status, location, and the like. A data subscription policy can consider localities associated with data subscriptions. For example, a data subscription that is not considered roaming where a user is located may be preferred over a data subscription that is considered roaming. As another example, a data subscription associated with a region may be able to access certain content and be preferred for applications that use the content over a data subscription associated with another region that may restrict that content. In some embodiments, power rule factors can include battery charge, overhead, and the like. A data subscription policy can consider power saving factors. For example, a data subscription associated with lower power consumption may be preferred when a device has low battery over a data subscription, or aggregation of data subscriptions, that may introduce overhead and increase power consumption.

At block 308, the hardware processor(s) 302 may execute the machine-readable/machine-executable instructions stored in the machine-readable storage media 304 to determine a primary data subscription and a secondary data subscription. In various embodiments, a device can be associated with multiple data subscriptions. These data subscriptions can correspond, for example, to multiple SIMs in the device. In various embodiments, a primary data subscription can be selected from multiple data subscriptions associated with a device. A secondary data subscription can be selected from the multiple data subscriptions associated with the device. In some embodiments, a primary data subscription and a secondary data subscription can be selected by a user or selected by a system. A user can select a desired data subscription to serve as the primary data subscription. The user can also indicate preferences for which applications will use the primary data subscription, a secondary data subscription, or an aggregation of the primary data subscription and the secondary data subscription. A system can select a data subscription to serve as the primary data subscription based on various characteristics associated with the data subscriptions. For example, the primary data subscription can be selected based on bandwidth, capacity, roaming status, and the like. It should be understood that the “primary” and “secondary” distinctions are not necessarily indicative of a preference for use, although in some embodiments, some preferences may impact selection of a data subscription for use by an application. As further described herein, a primary data subscription, a secondary data subscription, or an aggregation of both data subscriptions can be selected based on a data subscription policy and various other considerations.

At block 310, the hardware processor(s) 302 may execute the machine-readable/machine-executable instructions stored in the machine-readable storage media 304 to process a request for packet service from an application. In various embodiments, a device can process a request for packet service from an application on the device. Processing the request for packet service can involve determining information associated with the device, determining information associated with the application, determining information associated with a network to use for packet service, determining user preferences, and the like. In some embodiments, information associated with a device can include, for example, a location associated with the device, a battery level associated with the device, and the like. In some embodiments, information associated with an application can include, for example, bandwidth requirements, usage (e.g., work related use, personal use), priority (e.g., foreground application, background application, high priority application, low priority application), and the like. In some embodiments, information associated with a network can include, for example, quality of service, connection information, roaming status, network information, and the like. Based on the information determined, selection and aggregation of data subscriptions can be performed.

At block 312, the hardware processor(s) 302 may execute the machine-readable/machine-executable instructions stored in the machine-readable storage media 304 to establish one or more data connections for the application through at least one of the primary data subscription or the secondary data subscription based on the data subscription policy. In various embodiments, when a request for packet service from an application is processed, various information can be determined based on the request. A primary data subscription or a secondary data subscription, or both, can be used to establish one or more data connections for the application based on the information and a data subscription policy. In some embodiments, a data connection can be established for a foreground application or a high priority application through a primary data subscription. A data connection can be established for a background application or a low priority application through a secondary data subscription. In general, the primary data subscription is associated with higher data performance than the secondary data subscription. Thus, foreground applications or high priority applications, such as messaging applications, or other applications that generally receive immediate user attention, can use the primary data subscription. In some embodiments, a data connection can be established for applications running on a device and another data connection can be established for tethering usage (e.g., USB tethering, Wi-Fi-tethering). In this way, external data traffic is provided through a dedicated data subscription and does not impact data performance of the data subscription that the applications running on the device are using. Furthermore, data security can be improved by separating internal data traffic and external data traffic. The data connection established for the applications running on the device can be through a primary data subscription or a secondary data subscription based on a priority of the applications running on the device compared to a priority of tethering usage. In some embodiments, a data connection can be established for an application based on real time conditions. Data capabilities of a data subscription (e.g., primary data subscription, secondary data subscription) can be evaluated based on RAT information, bandwidth information, carrier aggregation information, radio conditions, and the like. A data subscription can be selected to provide a data connection to an application based on bandwidth requirements associated with the application and the data capabilities of the data subscription. In some embodiments, a data connection can be established based on network slice information. For example, a 5G new radio (NR) network can support enhanced mobile broadband (eMBB) traffic and ultra-reliable low latency communications (URLLC) traffic. A data connection can be established for an application that uses eMBB traffic through a data subscription (e.g., primary data subscription, secondary data subscription), and another data connection can be established for another application that uses URLLC traffic through another data subscription. In general, eMBB traffic is associated with higher bandwidth while URLLC traffic is associated with lower delay. So, an application with higher bandwidth requirements can use a data connection through a data subscription for eMBB traffic, and an application with delay sensitivity requirements can use a data connection through a data subscription for URLLC traffic. In some embodiments, a data connection can be established based on delay sensitivity. An application that is delay sensitive (e.g., online gaming application) can use a data connection through a data subscription based on the data subscription experiencing less latency than other data subscriptions. Applications that are not delay sensitive can use data connections through another data subscription so as to avoid delay on the data connection associated with the delay sensitive application. In some cases, conditions may cause one data subscription that was experience less latency than another data subscription to experience higher latency than the other data subscription. In these cases, the data connections associated with the data subscriptions can switch to maintain lower latency for delay sensitive applications. In some embodiments, a data connection can be established based on load balancing considerations. As more data connections are established through a data subscription (e.g., primary data subscription), the data subscription may reach its bandwidth capacity. To balance load across multiple data subscriptions, some data connections can be switched to another data subscription (e.g., secondary data subscription). In some embodiments, a data connection can be established based on data limits or roaming statuses. Some data subscriptions are associated with data limits (e.g., 100 Mb/day, 25 Gb/month). If a data subscription (e.g., primary data subscription) reaches its data limit or is within a threshold amount of its data limit, data connections associated with the data subscription can be switched to another data subscription (e.g., secondary data subscription). If a data subscription (e.g., primary data subscription) is associated with roaming status, data connections associated with the data subscription can be switched to another data subscription (e.g., secondary data subscription). In some embodiments, a data connection can be established based on usage of an application. An application used for work related purposes or for other non-personal purposes can use a data connection through a data subscription associated with the work related purpose or other non-personal purpose. For example, an employer may provide SIMs to its employees for work related purposes. Applications used for work related purposes can use data connections through a data subscription associated with the SIM provided by the employer.

In some embodiments, establishing one or more data connections for an application can involve aggregating data connections through the primary data subscription and the secondary data subscription. In some cases, the aggregation of data connections can involve dividing data to be received through the data connections based on a data range. For example, download of a data file through aggregated data connections can involve downloading a first data range (e.g., first half of the data file) from a first data connection and downloading a second data range (e.g., second half of the data file) from a second data connection. In some cases, the aggregation of data connections can involve dividing data to be received through the data connections based on a time range. For example, download of a video file through aggregated data connections can involve downloading a first time range (e.g., first 30 seconds of the video file) through a first data connection and downloading a second time range (e.g., second 30 seconds of the video file) through a second data connection. The aggregation of data connections can be based on satisfaction of certain conditions. In some embodiments, aggregation of data connections can be based on user preferences. A user can specify a threshold data size or a threshold throughput for aggregation of data connections. Data connections can be aggregated, for example, in response to a request for a file that satisfies or exceeds the threshold data size or in response to a request for throughput that satisfies or exceeds the threshold throughput. In some embodiments, aggregation of data connections can be based on external data sharing. In some cases, a device may be used primarily for external data sharing (e.g., as a Wi-Fi hotspot). Data connections can be aggregated, for example, when a number of applications on the device is below a threshold number while external data sharing is active, when a number of clients associated with external data sharing satisfies or exceeds a threshold number, when requested data throughput associated with external data sharing satisfies or exceeds a threshold throughput, and the like. In some embodiments, aggregation of data connections can be based on application requirements. Data connections can be aggregated, for example, when an application request throughput that exceeds remaining capacities of available data subscriptions, when a requested file size exceeds a file size threshold, when an application requests a transmission burst (e.g., high throughput for a period of time), such as to reduce initial buffering time, and the like.

The aggregation of data connections can be stopped based on satisfaction of certain conditions. In certain conditions, improvements associated with aggregation of data connections may not warrant aggregating the data connections. For example, aggregation of data connections can be stopped if a battery level of a device falls below a threshold battery level. As another example, aggregation of data connections can be stopped if the data capacities of the data subscriptions associated with the data connections are below threshold capacities. As another example, aggregation of data connections can be stopped for a file download when a remaining file size of the file download is less than a threshold file size.

In some embodiments, establishing one or more data connections for an application can involve recovery of a service failure or a service degradation. In some cases, a data connection may experience an interruption, such as a data stall, a disconnection, a server timeout, and the like, or experience a performance degradation, such as a reduction in throughput, an increase in latency, and the like. In these cases, the data connection can be switched to another data subscription temporarily. While the data connection is switched to the other data subscription, the data subscription on which the data connection experienced the service failure or the service degradation can be reset or restarted. After the data connection that was reset or restarted is available again and no longer experiencing the service failure or the service degradation, the data connections can be switched back to this data connection.

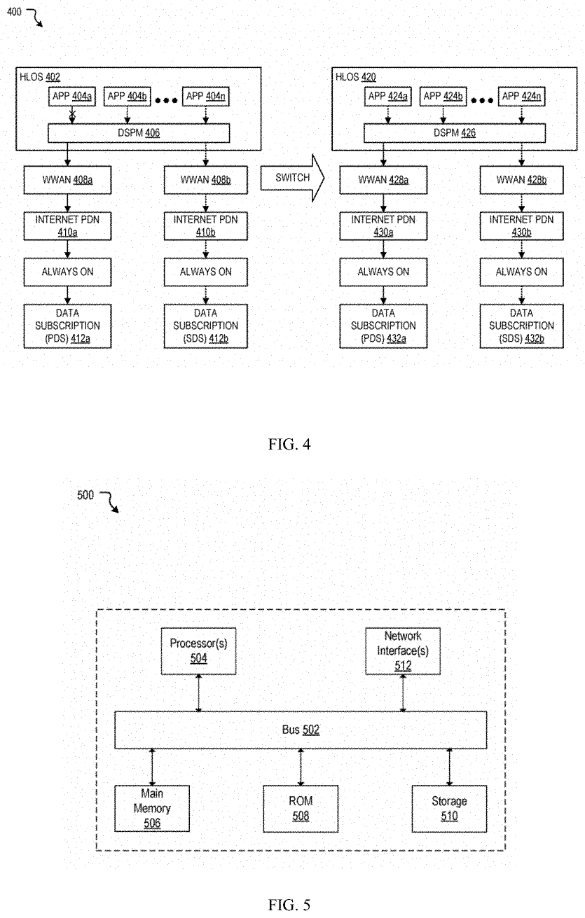

FIG. 4 illustrates an example scenario 400 associated with recovery of a service failure or a service degradation according to various embodiments of the present disclosure. As illustrated in FIG. 4, a number of applications, APP 404a, APP 404b, APP 404n, are operating in a high level operating system (HLOS) 402. A data subscription policy manager (DSPM) 306 supports data connections, WWAN 408a, WWAN 408b, to facilitate access to Internet PDN 310a and Internet PDN 410b. These data connections can be effectuated through SIMs associated with a primary data subscription (PDS) 412a and a secondary data subscription (SDS) 412b. In this example, APP 404a uses a data connection WWAN 408a supported by PDS 412a. APP 404b and APP 404n use a data connection WWAN 408b supported by SDS 412b. A service failure or a service degradation can be determined for APP 404a, indicating that PDS 412a may be experiencing an issue. Based on the service failure or the service degradation, the data connection associated with APP 404a can be switched to another data subscription. As illustrated in FIG. 4, following the switch, the applications APP 424a, 424b, 424n use a data connection WWAN 428b supported by SDS 432b. No application uses the data connection WWAN 428a supported by PDS 432a.

During this time, PDS 432a can be reset or otherwise recovered back to normal operating status.

FIG. 5 illustrates a block diagram of an example computing system 500 in which various embodiments of the present disclosure may be implemented. The computing system 500 can include a bus 502 or other communication mechanism for communicating information, one or more hardware processors 504 coupled with the bus 502 for processing information. The hardware processor(s) 504 may be, for example, one or more general purpose microprocessors. The computing system 500 may be an embodiment of a video encoding module, video decoding module, video encoder, video decoder, or similar device.

The computing system 500 can also include a main memory 506, such as a random access memory (RAM), cache and/or other dynamic storage devices, coupled to the bus 502 for storing information and instructions to be executed by the hardware processor(s) 504. The main memory 506 may also be used for storing temporary variables or other intermediate information during execution of instructions by the hardware processor(s) 504. Such instructions, when stored in a storage media accessible to the hardware processor(s) 504, render the computing system 500 into a special-purpose machine that can be customized to perform the operations specified in the instructions.

The computing system 500 can further include a read only memory (ROM) 508 or other static storage device coupled to the bus 502 for storing static information and instructions for the hardware processor(s) 504. A storage device 510, such as a magnetic disk optical disk, or USB thumb drive (Flash drive), etc., can be provided and coupled to the bus 502 for storing information and instructions.

Computing system 500 can further include at least one network interface 512, such as a network interface controller module (NIC), network adapter, or the like, or a combination thereof, coupled to the bus 502 for connecting the computing system 700 to at least one network.

In general, the word “component,” “modules,” “engine,” “system,” “database”, and the like, as used herein, can refer to logic embodied in hardware or firmware, or to a collection of software instructions, possibly having entry and exit points, written in a programming language, such as, for example, Java, C or C++. A software component or module may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices, such as the computing system 500, may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of an executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computing system 500 may implement the techniques or technology described herein using customized hard-wired logic, one or more ASICs or FPGAs, firmware and/or program logic which in combination with the computing system 700 that causes or programs the computing system 500 to be a special-purpose machine. According to one or more embodiments, the techniques described herein are performed by the computing system 700 in response to the hardware processor(s) 504 executing one or more sequences of one or more instructions contained in the main memory 506. Such instructions may be read into the main memory 506 from another storage medium, such as the storage device 510. Execution of the sequences of instructions contained in the main memory 506 can cause the hardware processor(s) 504 to perform process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may include non-volatile media and/or volatile media. The non-volatile media can include, for example, optical or magnetic disks, such as the storage device 510. The volatile media can include dynamic memory, such as the main memory 506. Common forms of the non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, an EPROM, a FLASH-EPROM, an NVRAM, any other memory chip or cartridge, and networked versions of the same.

Non-transitory media is distinct from but may be used in conjunction with transmission media. The transmission media can participate in transferring information between the non-transitory media. For example, the transmission media can include coaxial cables, copper wire and fiber optics, including the wires that include the bus 502. The transmission media can also take a form of acoustic or light waves, such as those generated during radio-wave and infrared data communications.

The computing system 500 also includes a network interface 518 coupled to bus 502. Network interface 518 provides a two-way data communication coupling to one or more network links that are connected to one or more local networks. For example, network interface 518 may be an integrated services digital network (ISDN) card, cable modem, satellite modem, or a modem to provide a data communication connection to a corresponding type of telephone line. As another example, network interface 518 may be a local area network (LAN) card to provide a data communication connection to a compatible LAN (or WAN component to communicated with a WAN). Wireless links may also be implemented. In any such implementation, network interface 518 sends and receives electrical, electromagnetic, or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the worldwide packet data communication network now commonly referred to as the “Internet.” Local network and Internet both use electrical, electromagnetic, or optical signals that carry digital data streams. The signals through the various networks and the signals on network link and through network interface 518, which carry the digital data to and from computing system 500, are example forms of transmission media.

The computing system 500 can send messages and receive data, including program code, through the network(s), network link and network interface 518. In the Internet example, a server might transmit a requested code for an application program through the Internet, the ISP, the local network, and the network interface 518.

The received code may be executed by processor 504 as it is received, and/or stored in storage device 510, or other non-volatile storage for later execution.

Each of the processes, methods, and algorithms described in the preceding sections may be embodied in, and fully or partially automated by, code components executed by one or more computing systems or computer processors including computer hardware. The one or more computing systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computing systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computing system 500.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. An electronic device-implemented method comprising:
determining a primary data subscription and a secondary data subscription for the electronic device;
processing a request for packet service from an application associated with the electronic device; and
establishing one or more data connections for the application in response to the request for packet service through at least one of the primary data subscription or the secondary data subscription based on a data subscription policy.

2. The electronic device-implemented method of claim 1, wherein the data connections are established through the primary data subscription and the secondary data subscription, the method further comprising:
aggregating the data connections based on a satisfaction of an aggregation condition, wherein the aggregation condition is based on at least one of: user preferences, a threshold data size, a threshold throughput, external data sharing, or capacities associated with the primary data subscription and the secondary data subscription.

3. The electronic device-implemented method of claim 2, further comprising:
stopping aggregation of the data connections based on a satisfaction of a stop aggregation condition, wherein the stop aggregation condition is based on at least one of: a threshold battery level, a threshold data capacity, or a threshold file size.

4. The electronic device-implemented method of claim 1, wherein the one or more data connections are associated with a service failure or a service degradation, and the method further comprising:
switching the one or more data connections to be through a different data subscription;
recovering a data subscription associated with the service failure or the service degradation to obtain a recovered data subscription; and
switching the one or more data connections to be through the recovered data subscription.

5. The electronic device-implemented method of claim 1, further comprising:
determining policy rule factors for the data subscription policy associated with the electronic device, wherein the policy rule factors are based on at least one of user preferences, capacity rule factors, application rule factors, traffic rule factors, load balance rule factors, use rule factors, status rule factors, or power rule factors.

6. The electronic device-implemented method of claim 1, wherein the determining the primary data subscription and the secondary data subscription is based on a user selection or a system selection.

7. The electronic device-implemented method of claim 1, wherein the processing the request for packet service comprises at least one of: determining information associated with the electronic device, determining information associated with the application, determining information associated with a network for packet service, or determining user preferences.

8. An electronic device comprising:
at least one processor; and
a memory storing instructions that, when executed by the at least one processor, and cause the electronic device to perform:
determining a primary data subscription and a secondary data subscription for the electronic device;
processing a request for packet service from an application associated with the electronic device;
establishing data connections for the application in response to the request for packet service through the primary data subscription and the secondary data subscription based on a data subscription policy; and
aggregating the data connections based on a satisfaction of an aggregation condition, wherein the aggregation condition is based on at least one of: user preferences, a threshold data size, a threshold throughput, external data sharing, or capacities associated with the primary data subscription and the secondary data subscription.

9. The electronic device of claim 8, further performing:
stopping aggregation of the data connections based on a satisfaction of a stop aggregation condition, wherein the stop aggregation condition is based on at least one of: a threshold battery level, a threshold data capacity, or a threshold file size.

10. The electronic device of claim 8, wherein one of the data connections is associated with a service failure or a service degradation, and the electronic device further performs:
switching the one data connection to be through a different data subscription;
recovering a data subscription associated with the service failure or the service degradation to obtain a recovered data subscription; and
switching the one data connection to be through the recovered data subscription.

11. The electronic device of claim 8, further performing:
determining policy rule factors for the data subscription policy associated with the electronic device, wherein the policy rule factors are based on at least one of user preferences, capacity rule factors, application rule factors, traffic rule factors, load balance rule factors, use rule factors, status rule factors, or power rule factors.

12. The electronic device of claim 8, wherein the determining the primary data subscription and the secondary data subscription is based on a user selection or a system selection.

13. The electronic device of claim 8, wherein the processing the request for packet service comprises at least one of: determining information associated with the electronic device, determining information associated with the application, determining information associated with a network for packet service, or determining user preferences.

14. A non-transitory storage medium of an electronic device storing instructions that, when executed by at least one processor of the electronic device, cause the electronic device to perform:
determining a primary data subscription and a secondary data subscription for an electronic device;
processing a request for packet service from an application associated with the electronic device;
establishing a first data connection for the application in response to the request for packet service through the primary data subscription based on a data subscription policy;
determining a service failure or a service degradation associated with the first data connection;
switching the first data connection to be through the secondary data subscription;
recovering the primary data subscription; and
switching the first data connection to be through the primary data subscription.

15. The non-transitory storage medium of claim 14, wherein the instructions cause the electronic device to further perform:
establishing a second data connection through the secondary data subscription; and
aggregating the first data connection and the second data connection based on a satisfaction of an aggregation condition, wherein the aggregation condition is based on at least one of: user preferences, a threshold data size, a threshold throughput, external data sharing, or capacities associated with the primary data subscription and the secondary data subscription.

16. The non-transitory storage medium of claim 15, wherein the instructions cause the electronic device to further perform:
stopping aggregation of the first data connection and the second data connection based on a satisfaction of a stop aggregation condition, wherein the stop aggregation condition is based on at least one of: a threshold battery level, a threshold data capacity, or a threshold file size.

17. The non-transitory storage medium of claim 16, wherein the instructions cause the electronic device to further perform:
determining policy rule factors for the data subscription policy associated with the electronic device, wherein the policy rule factors are based on at least one of user preferences, capacity rule factors, application rule factors, traffic rule factors, load balance rule factors, use rule factors, status rule factors, or power rule factors.

18. The non-transitory storage medium of claim 14, wherein the determining the primary data subscription and the secondary data subscription is based on a user selection or a system selection.

19. The non-transitory storage medium of claim 14, wherein the processing the request for packet service comprises at least one of: determining information associated with the electronic device, determining information associated with the application, determining information associated with a network for packet service, or determining user preferences.

20. The non-transitory storage medium of claim 14, wherein the service failure comprises a data stall, a disconnection, or a server timeout, and the service degradation comprises a reduction in throughput, or an increase in latency.
